(19) United States
(12) Patent Application Publication
(10) Pub. No.: US 2003/0040982 A1
(43) Pub. Date: Feb. 27, 2003

(54) Advertisement campaign method for automated service system

(75) Inventor: Hung-Chun Yang, Taipei City (TW)

Correspondence Address: BACON & THOMAS, PLLC, 625 SLATERS LANE, FOURTH FLOOR, ALEXANDRIA, VA, 22314

(73) Assignee: United World Chinese Commercial Bank, Taipei (TW)

(21) Appl. No.: 09/938,632

(22) Filed: Aug. 27, 2001

(51) Int. Cl. G06F 17/60

(52) U.S. Cl. 705/27

(57) ABSTRACT

An advertisement campaign method has steps of entering the preset transaction process; wherein when a user is using the automated service system for transaction, the automated service system provides preset processes; data input; wherein data is input according to the preset processes; data processing and transmission; wherein the automated service system processes the chosen preset process or sends it to a information center for further processing; linking and displaying advertisement; wherein the automated service system links an advertisement databank so that the system is able to display the advertisement with a screen; and accomplishing data processing and transfer; wherein after the data is processed, the advertisement display is selectively stopped and then the system returns the screen back to the transaction picture for another transaction or predetermined processes.

### BACKGROUND OF THE INVENTION

1. Field of the invention

The present invention relates to an advertisement campaign method, and more particularly to an advertisement campaign method for an automated service system. The method is able to exhibit advertisement according to a preset program so that a series of advertisements are sequentially presented or a sole advertisement is repeatedly played.

2. Prior art description

Nowadays, automated service system is provided almost everywhere. With the convenience of the automated service system, users are able to have access to valuable information. The following description is based on one of the automated service system, the ATM (automated teller machine), for reference. With reference to FIG. 4, the conventional ATM system provides the user the following processes for transaction:

Entering the preset transaction process 92;

When the user approaches the ATM system and inserts the ATM card, the user initiates a series of preset transactions.

Inputting data 93;

After the ATM card is inserted into the system, the user chooses from the preset programs or the user is able to choose to input data to initiate programs such as language change, cash withdraw, transfer funds, change code, balance inquiry....

Data processing 94;

After the program is chosen and related data is inputted according to the instruction shown on the ATM screen, the data is being processed. While the data is processed, the user waits in front of the ATM. Meantime, the ATM screen shows “Data processing” or the logo or other services of the bank. The data processing step comprises code verification, whether the card is declared lost, stop payment or the account is being frozen, whether the balance is enough for deduction or the cash withdraw or funds transfer exceeds daily allowance.

Post process 95;

After the previous chosen program is finished, the ATM switches back to the original transaction picture for further transaction program choosing.

As described in step 91, most advertisement is played while there is no user using the ATM. Further, for safety sake, most pedestrians do not pay too much attention to the advertisement on the ATM screen. Accordingly, there is almost no effect to the advertisement provider. Because most advertisements are compiled with the ATM system program, the maintenance technique to the software or hardware is held by the ATM provider. Therefore, if the bank wants to change its logo or any information shown on the screen, the bank needs to ask for technique support from the ATM provider.

To overcome the shortcomings, the present invention intends to provide an improved advertisement campaign method for automatic service system to mitigate or obviate the aforementioned problems.

### SUMMARY OF THE INVENTION

The primary objective of the invention is to provide an advertisement campaign method which is able to capture the “loophole” in transaction to display advertisement so as to achieve the purpose of advertisement.

Another objective of the invention is to provide a communication mode so that the bank needs not the ATM provider to provide services concerning the change of advertisement content.

Other objects, advantages and novel features of the invention will become more apparent from the following detailed description when taken in conjunction with the accompanying drawings.

### BRIEF DESCRIPTION OF THE DRAWINGS

FIG. 1 is a flow chart of the present invention;

FIG. 2 is a schematic view showing the preferred embodiment of the invention;

FIG. 3 is a flow chart of the communication mode of the invention; and

FIG. 4 is a flow chart of a conventional ATM.

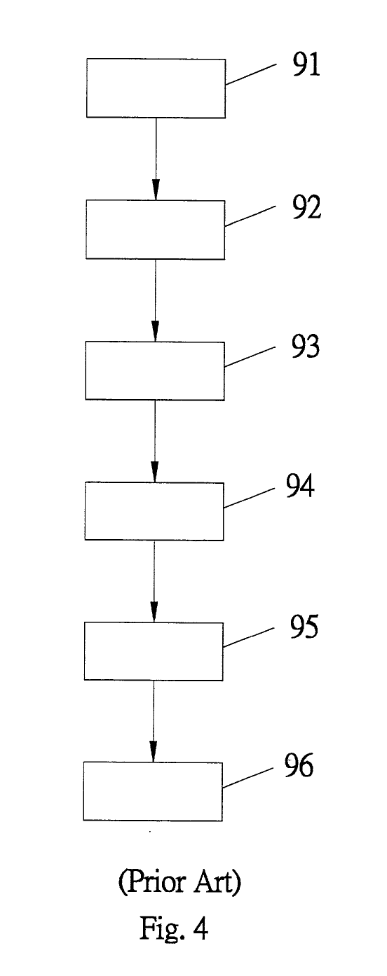

### DETAILED DESCRIPTION OF PREFERRED EMBODIMENT

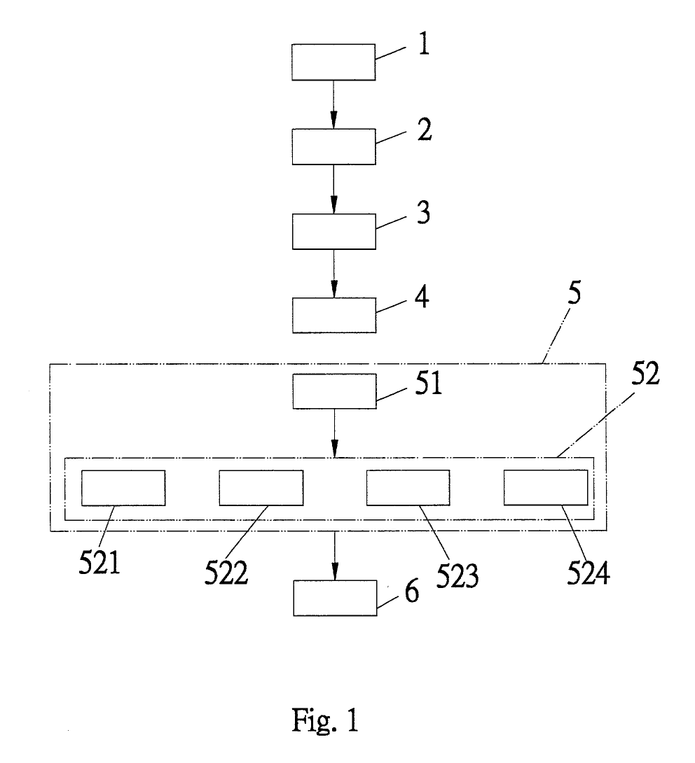

With reference to FIGS. 1 to 3, the preferred embodiment of the invention is applied to an automatic teller machine (ATM) and thus the advertisement campaign method of the present invention includes the following steps:

Step 1; advertisement campaign while there is no user;

When there is no user using the ATM, the ATM screen 71 displays pictures such as a preset advertisement, a logo or “insert card”.

Step 2, entering the preset transaction process;

When a user is using the ATM automatic service system 7 for transaction, the ATM provides preset processes such as “insert ATM card”, “password entering”.

Step 3, data input;

The user chooses the services or inputting further information based on the preset processes, which includes language change, cash withdraw, transfer funds, change code, balance inquiry . . . .

Step 4, data processing and transmission;

The automatic service system 7 processes the user's data or sends it to the information center 72.

Step 5, linking and displaying advertisement;

The automatic service system 7 links the advertisement databank at step 4 so that the system 7 is able to display the advertisement with the screen 71, wherein the advertisement databank link comprises:

Step 51, presetting advertisement file;

At least one advertisement is stored in a memory center and has expiring data for the at least one advertisement. Furthermore, at least one fixed advertisement is predetermined in the at least one advertisement.

Step 52, displaying advertisement;

The at least one advertisement is retrieved from the memory center and displayed. If the expiring data for the at least one advertisement does not fit with the predetermined data (expired or invalid), the at least one fixed advertisement is displayed.

The display of the advertisement is chosen among the following different ways:

1. Fixed-time, single-rotation, multiple advertisement change 521;

A single advertisement is retrieved from the memory center and displayed for a specific time period during each of the data processing waiting periods and each of the rest of the advertisements is displayed by turns.

2. Fixed-time, single-rotation, sole advertisement play 522;

A single advertisement is displayed at each of the data processing waiting period until the next transaction is chosen by the user and the data is processed. It is noted that should the lasting time of each of the advertisement be too short, it is not easy to impress the user. Therefore, it is best to adopt this approach.

3. Unspecific display time period 523;

Once the data processing is finished, the advertisement display is stopped.

3. Combination display 524;

The foregoing fixed-time, single-rotation, multiple advertisement change, fixed-time, single-rotation, sole advertisement play and the unspecific display time period are mixed according to different requirements.

Step 6, accomplishing data processing and transfer;

After the data is processed, the system stops the advertisement display or waits for the finish of the advertisement display. Then the system 7 shows the result of the transaction and returns the screen 71 back to the transaction picture for the user to choose another transaction or predetermined processes.

It is noted that most users focus their attention on the screen during the entire transaction period, which allows the advertisement campaign to have its ultimate effect to the user. Furthermore, during the transaction, there will be no commercials or any disruption like the TV program. Accordingly, the advertisement effect on the users is enormous.

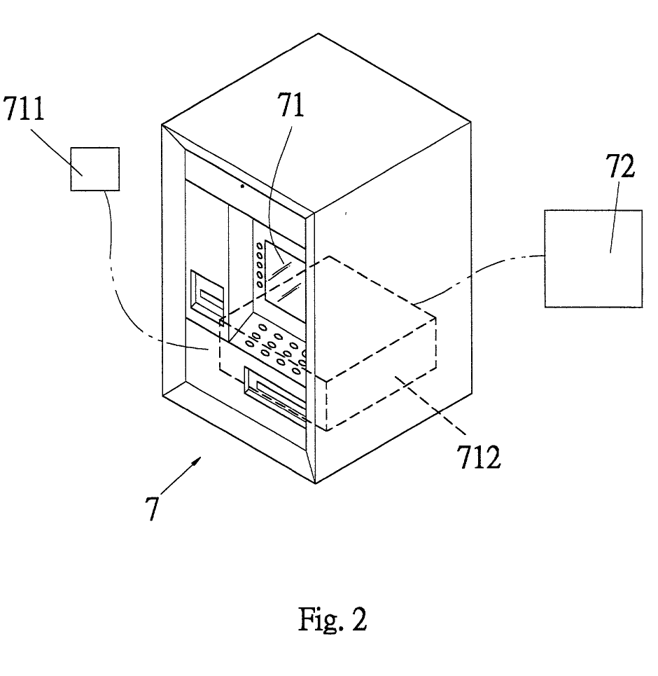

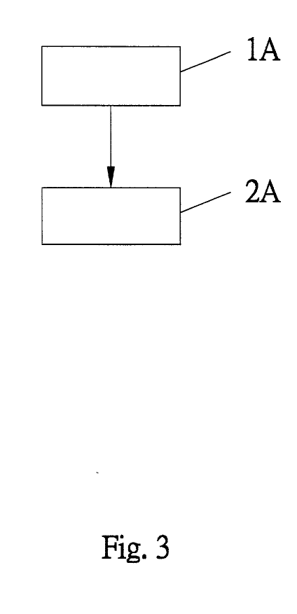

With reference to FIGS. 2 and 3, the link of the method comprises the following steps:

Step 1A, setup a communication mode;

The automatic service system 7 has an isolated communication mode 711. The communication mode 711 is separate from the system 7 and has a programmable part so that with the communication mode 711, the advertisement in the memory center is able to be edited.

Step 2A, communication, comparison and update;

The data processing unit 712 communicates with the communication mode 711. Then, the programmable part compares and updates the content of the advertisement such as the categories of the advertisement and the filename of the system 7 for editing and then records every change so as to provide to the system 7. Within the embodiment, the content of the advertisement is able to be changed by diskette, internet, radio transmission, satellite or any other suitable method.

The following is a more detailed description to the link method of the invention.

Step 1A, setup a communication mode;

It is first to setup a changeable part in the ATM system, for example, a screen picture filename is selected and thus created. All the available advertisements and the related data concerning the expiring date and invalid conditions of the advertisements are stored within the screen picture filename. Thereafter, a new command in relation to the processing of the screen picture is added to the ATM system program. After the comparison and update as described in step 2A, the advertisement(s) is displayed.

It is therefore noted that in order to change any picture or any advertisement inside the screen picture filename, after a suitable approach is chosen, such as the internet, diskette, etc. a new picture or advertisement with the same name as that used in the screen picture filename is then able to replace the old one in the screen picture filename. The advertisements that are not changed are still kept inside the system and will not be displayed on the screen 71 until all the requirement are met.

It concludes that the method of the present invention has the following advantages:

1. The advertisement is displayed during the data processing waiting period, which captures all the attention of the users and thus achieves the ultimate advertisement effect.

2. The communication mode 711 is able to communicate with the ATM system 7 so as to change any advertisement or information inside the system 7 and thus time and cost are saved.

3. Additional income from advertisement is expected. Because the method allows different advertisements to be displayed by turns, additional benefit is expected.

4. The content of the advertisement is able to change at any suitable time and the most important thing is that the timing of change of the advertisement is controlled by the advertisement provider. There is no need of technique assistance from the ATM system provider and thus labor and cost burden is lessened.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An advertisement campaign method for automated service system comprising the following acts:
(A) entering the preset transaction process; wherein when a user is using the automated service system for transaction, the automated service system provides preset processes;
(B) data input; wherein data is input according to the preset processes;
(C) data processing and transmission; wherein the automated service system processes the chosen preset process or sends it to a information center for further processing;
(D) linking and displaying advertisement; wherein the automated service system links an advertisement databank at step (C) so that the system is able to display the advertisement with a screen;
(E) accomplishing data processing and transfer; wherein after the data is processed, the advertisement display is selectively stopped and then the system returns the screen back to the transaction picture for another transaction or predetermined processes.

2. The method as claimed in claim 1, wherein the advertisement display is stopped immediately after the transaction is finished at step (E).

3. The method as claimed in claim 1, wherein the system returns the screen back to the transaction picture after advertisement display is finished.

4. The method as claimed in claim 1, wherein the advertisement linking step comprises:
(A) presetting advertisement file, wherein at least one advertisement is stored in a memory center;
(B) displaying advertisement, wherein the at least one advertisement is retrieved from the memory center and displayed.

5. The method as claimed in claim 4, wherein the at least one advertisement has corresponding expiring date and invalid conditions and further has at least one fixed advertisement so as to replace the at least one advertisement if the corresponding expiring date and invalid conditions is the same as those predetermined in the system.

6. The method as claimed in claim 4, wherein the advertisement display is fixed-time, single-rotation, multiple advertisements change, each of the display lasts for a specific time period.

7. The method as claimed in claim 4, wherein the advertisement display is fixed-time, single rotation, sole advertisement play, each advertisement is played by turns during the data processing time period.

8. The method as claimed in claim 1, wherein the automatic service system is an automatic teller machine.

9. An advertisement linking method for automatic service system comprising the following acts:
(A) setup a communication mode; wherein the automatic service system has an isolated communication mode which is separate from the system and has a programmable part so that with the communication mode, the advertisement in a memory center is able to be edited;
(B) communication, comparison and update; wherein a data processing unit communicates with the communication mode and then, the programmable part compares and updates content of the advertisement for editing and then records every change so as to provide to the system.

10. The method as claimed in claim 9, wherein the content of comparison and update is the filename of an advertisement unit and a system edit unit inside the system.

11. The method as claimed in claim 9, wherein the automatic service system is an automatic teller machine.
